(19) United States
(12) Patent Application Publication
(10) Pub. No.: US 2025/0298796 A1
(43) Pub. Date: Sep. 25, 2025

(54) CACHING PATTERN FOR LARGE LANGUAGE MODEL INTERFACE

(71) Applicant: Insight Direct USA, Inc., Chandler, AZ (US)

(72) Inventor: Amol Ajgaonkar, Chandler, AZ (US)

(21) Appl. No.: 18/771,552

(22) Filed: Jul. 12, 2024

Related U.S. Application Data
(60) Provisional application No. 63/568,180, filed on Mar. 21, 2024.
(60) Provisional application No. 63/632,921, filed on Apr. 11, 2024.

(51) Int. Cl. G06F 16/2453

(52) U.S. Cl. CPC G06F 16/24539

(57) ABSTRACT

A method of generating an automated response to a user prompt includes receiving, by a processor of a network-connected device, a first natural-language prompt from a user; generating, by the processor, a first vector embedding representative of the first natural-language prompt; querying a vector database using the first vector embedding to identify a second vector embedding representative of a second natural-language prompt and having a similarity score with the first vector embedding above a defined threshold, wherein the vector database comprises a plurality of vector embeddings stored in association with a response identifier, each vector embedding representative of a natural language prompt; and producing a first natural-language response to the first natural-language prompt, wherein producing the first natural-language response comprises retrieving, by the processor, the first natural-language response to the second natural language prompt from a cache database when the second vector embedding is identified in querying the vector database.

### CROSS-REFERENCE TO RELATED APPLICATIONS

This application claims priority to U.S. Provisional Application No. 63/632,921, filed Apr. 11, 2024, and entitled “CACHING PATTERN FOR LARGE LANGUAGE MODEL INTERFACE,” and it also claims priority to U.S. Provisional Application No. 63/568,180, filed Apr. 21, 2024, and entitled “CACHING PATTERN FOR LARGE LANGUAGE MODEL INTERFACE,” the disclosures of which are hereby incorporated by reference in their entirety.

### FIELD OF THE INVENTION

The present disclosure relates generally to generative language models and, more particularly, to systems and methods for reducing latency in response generation.

### BACKGROUND

Generative artificial intelligence (AI) language models, such as large language models (LLMs), are capable of dynamically generating content based on user prompts. While a language model may receive the same or similar prompts from multiple users, content is generated anew each time the prompt is provided to the language model. There is often as associated financial cost to the user for each use of the language model. Additionally, there is an associated latency in generating content for each use of the language model that generally cannot be avoided when responding to the same or similar prompts.

### SUMMARY

A method of generating an automated response to a user prompt includes receiving, by a processor of a network-connected device, a first natural-language prompt from a user; generating, by the processor, a first vector embedding representative of the first natural-language prompt; querying, by the processor, a vector database using the first vector embedding to identify a second vector embedding representative of a second natural-language prompt and having a similarity score with the first vector embedding above a defined threshold, wherein the vector database comprises a plurality of vector embeddings stored in association with a response identifier, each vector embedding representative of a natural language prompt; and producing a first natural-language response to the first natural-language prompt, wherein producing the first natural-language response comprises retrieving, by the processor, the first natural-language response to the second natural language prompt from a cache database when the second vector embedding is identified in querying the vector database.

A system includes a vector database configured to store vector embeddings representative of natural-language prompts and associated response identifiers; a cache database configured to store the associated response identifiers and corresponding natural-language responses to the natural-language prompts, each response identifier associated with a vector embedding of the vector database and a natural-language response of the cache database; and a network-connected device in electronic communication with the vector database and the cache database. The network-connected device includes a processor configured to receive a first natural-language prompt from a user, generate a query vector representative of the first natural-language prompt, query the vector database using query vector to identify a database vector having a similarity score with the query vector above a defined threshold, the database vector associated with a response identifier, and produce a first natural-language response to the first natural-language prompt by retrieving, from the cache database, a first natural-language response associated with the response identifier of the database vector when the database vector is identified; and submitting the first natural language prompt to a language model, executed by the processor, to generate a first natural-language response when the database vector is not identified.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for caching and reusing language model responses.

FIG. 2 is a flow diagram of an example of a method of generating an automated response to a user prompt using a caching system.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure is directed to systems and methods for reducing latency in response generation of generative artificial intelligence (AI) language models, such as large language models (LLMs). Language models are capable of dynamically generating content based on user prompts, but do not retain generated content to respond to the same or similar prompts when provided to the language model by another user or by the same user at a later time. In essence, each time the same or similar prompt (e.g., a question or request for information) is provided to the language model, the language model generates the response content anew. Depending on the content of the prompt, it may take the language model several seconds or longer to generate a response. In instances where the language model is required to query third party data, the response generation time can be even longer as the increased computational cost associated with generating response text increases the overall time required to generate the response text. The associated latency in generating a response can result in poor user experiences. Furthermore, if there is a financial cost associated with each use of the language model, there is an unnecessary redundant cost for regenerating the same content again and again.

The disclosed caching system is particularly suited for large entities, such as large businesses or organizations for making entity-specific information (e.g., human resources policies and procedures, technical information, etc.) available and easily accessible to many users (e.g., employees or customers). The disclosed caching system is particularly suited for disseminating specific requests for information to multiple users where the specific request is repeatedly made by different users. For example, multiple employees may have the same or similar questions relating to human resource policies such as sick leave or disability coverage. While the questions may not be identical, the information contained in the responses likely is. Each time the question is provided to a language model, the language model functions as if it is the first time the question has been asked, reanalyzing the same data sets, and generating a new response-perhaps not with identical text to previous responses, but typically containing the same information.

The present disclosure provides a caching system that reduces or eliminates the involvement of the language model in generating content for responses to prompts that have previously been provided or generated for the same or similar prompts. The disclosed caching system can significantly reduce the latency for response generation and can reduce or eliminate the costs associated with using the language model for prompts that are the same as or similar to prompts the language model has previously processed and responded to. As explained in further detail herein, in the disclosed caching system, a language model can be used to generate content for a response to the first instance a user-generated prompt is submitted or for a user-generated prompt for which no similar prompts and responses have been previously stored. If the user finds the response helpful, they can upvote or approve the response, which is then saved in association with the user-generated prompt for retrieval the next time the same or similar user-generated prompt is provided to the caching system. The systems and methods disclosed herein can significantly reduce the latency in response generation and can avoid unnecessary costs associated with redundant use of a language model. While the systems and methods disclosed herein are specifically designed for large entity language model users, they may be applied to more generalized language model use.

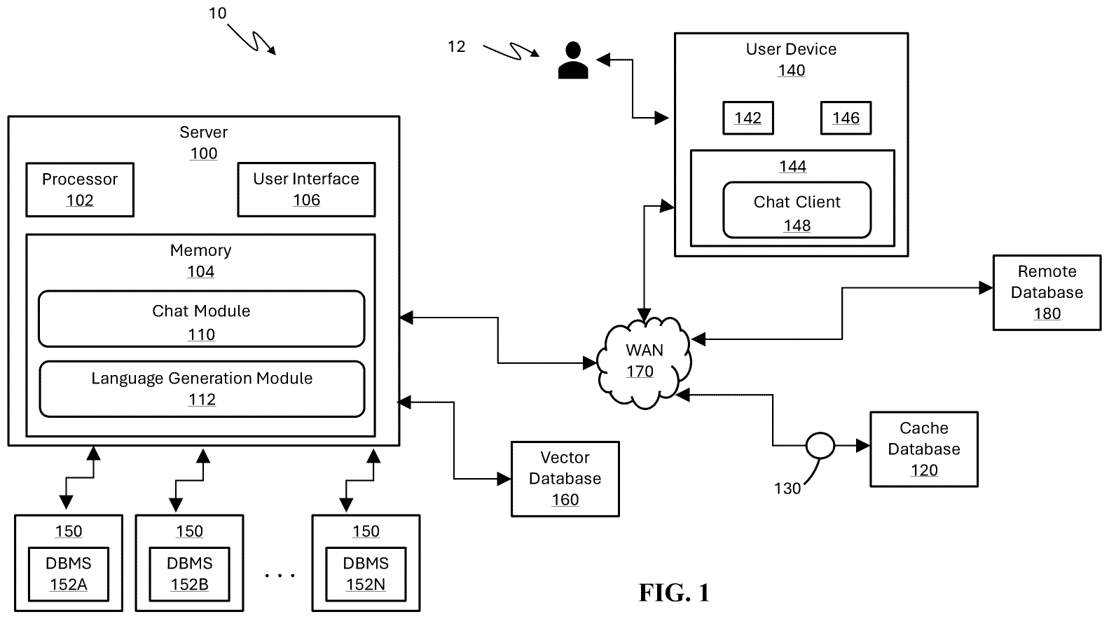

FIG. 1 is a schematic diagram of an example of a system for caching and reusing language model responses. FIG. 1 shows system 10, server 100, cache database 120, application programming interface (API) 130, user device 140, databases 150A-N, vector database 160, wide area network (WAN) 170, and remote database 180. Server 100 can include processor 102, memory 104, and user interface 106. Memory 104 can store chat module 110 and language generation module 112. User device 140 can include processor 142, memory 144, and user interface 146. Memory 144 can store chat client 148. Databases 150A-N can organize data using database management systems (DBMSs) 152A-N, respectively. FIG. 1 also depicts user 12. As explained in more detail below, vector database 160 can store natural-language prompts with representative vector embeddings and corresponding response IDs. Cache database 120 can store natural-language responses and corresponding response IDs associated with natural-language prompts and representative vector embeddings stored in vector database 160. One or more databases 150A-N, 180, and/or cache database 120 can store entity-specific information and/or user-specific information, which can be retrieved for language-model generated responses to user-generated prompts. Vector database 160 can be used to identify vector embeddings representative of stored natural-language prompts that are the same or substantially similar to a user-generated prompt such that the information contained in the associated natural-language responses would be substantially the same. When a natural-language prompt sufficiently similar to a user-generated prompt is identified, the associated response can be retrieved from cache database 120. Advantageously, the disclosed system 10 can improve response latency and reduce language model usage costs by retrieving stored natural-language responses to prompts that are the same as or substantially similar to newly submitted user-generated prompts.

Server 100 is a network-connected device that is connected to WAN 170 and user device 140. Server 100 can be network-connected to one or more remote databases 180 and cache database 120. Server 100 can include one or more hardware elements, devices, etc. for facilitating electronic communication with WAN 170, user device 140, remote database(s) 180, cache database 120, a local network, and/or any other suitable device via one or more wired and/or wireless connections. Although server 100 is generally referred to herein as a server, server 100 can be any suitable network-connectable computing device for performing the functions of server 100 detailed herein. Server 100 is configured to operate a chat service accessible to users via WAN 170. In particular, server 100 is configured to generate and/or retrieve natural-language responses to user-generated prompts.

Processor 102 can execute software, applications, and/or programs stored in memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on server 100 (e.g., by a computer-implemented machine-learning model or a data processing module) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator, such as user 12, to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

As will be described in more detail subsequently, server 100 generates or retrieves natural-language text responses based on user-provided natural-language prompts. Server 100 can generate or retrieve natural-language text responses for the chat service, such that the user-provided prompts and natural-language text responses generated or retrieved by server 100 mimic a conversation between two humans. Users can access chat functionality of server 100 by directly accessing server 100 (e.g., by user interface 106) and/or by accessing the functionality of server 100 through another device, such as user device 140.

User device 140 is a user-accessible electronic device that is directly connected to server 100 and/or is connected to server 100 via a local network. User device 140 includes processor 142, memory 144, and user interface 146, which are substantially similar to processor 102, memory 104, and user interface 106, respectively, and the discussion herein of processor 102, memory 104, and user interface 106 is applicable to processor 142, memory 144, and user interface 146, respectively. User device 140 can be, for example, a personal computer or any other suitable electronic device for performing the functions of user device 140 detailed herein.

Databases 150A-N are electronic databases that are directly connected to server 100 and/or are connected to server 100 via a local network. Each of databases 150A-N includes machine-readable data storage capable of retrievably housing stored data, such as database or application data. In some examples, one or more of databases 150A-N includes long-term non-volatile storage media, such as magnetic hard discs, optical discs, flash memories and other forms of solid-state memory, or forms of electrically programmable memories (EPROM) or electrically erasable and programmable (EEPROM) memories. In some examples, one or more databases 150A-N can store descriptive entity-specific information relevant to user queries. For example, one or more databases 150A-N can store documents relating to frequently asked questions, company policies and procedures, technical support, etc.

DBMS 152A-N are database management systems. As used herein, a “database management system” refers to a system of organizing data stored on a data storage medium. In some examples, a database management system described herein is configured to run operations on data stored on the data storage medium. The operations can be requested by a user and/or by another application, program, and/or software. The database management system can be implemented as one or more computer programs stored on at least one memory device and executed by at least one processor to organize and/or perform operations on stored data.

Language generation module 112 is a software element of server 100 and includes one or more programs for generating natural-language outputs based on natural language user-generated prompts as well as information retrieved from vector database 160, as described further herein. Language generation module 112 can use one or more trained, computer-implemented machine-learning models configured to generate natural-language responses to user-generated prompts. The one or more trained, computer-implemented machine-learning models can be, for example, one or more language models, such as one or more small language models and one or more large language models. The one or more language models can be, for example, one or more trained transformer models configured to generate natural-language outputs based on natural-language inputs. The language model(s) can be general-purpose natural-language model(s) and, in some examples, can be further trained and/or fine-tuned to generate language for system 10 using a transfer learning or similar approach.

Vector database 160 is an electronic database that stores natural-language text and vector embeddings representative of the natural-language text. Vector embeddings can be generated using an embedding model/algorithm that transforms natural-language text into vector embeddings representative of the text. The vector embeddings can represent, for example, the words or sentences of the natural-language text (e.g., word and sentence embeddings) and/or any other suitable element of the text. The natural-language text represented by the vector embeddings of vector database 160 can include user-generated prompts, portions of complex (e.g., multi-question or multi-part) user-generated prompts, operator-entered pre-generated prompts, and language model-generated prompts. Vector embeddings representative of natural-language prompts and stored in vector database 160 are referred to herein as “database vectors.”

Vector database 160 can store vector embeddings of pre-generated prompts provided to pre-populate vector database 160 to support initial use of system 10 by a user. For example, vector database 160 can be pre-populated with vector embeddings of common user prompts or requests for information. Vector database 160 can be pre-populated by generating vector embeddings for operator-input frequently asked questions or language model-generated questions based on content provided to language generation module 112. Content provided to the language generation module 112 can include, for example, frequently asked questions documents, transcripts of customer support, entity-specific documents (e.g., human resource policies), etc. Content for prompt generation can be retrieved from vector database 160, databases 150A-N, and/or remote database 180. A language model of language generation module 112 can be prompted to provide a list of questions asked or likely to be asked based on the content provided. Questions can be stored in vector database 160 as natural-language prompts and corresponding vector embeddings. Responses to pre-generated prompts can be generated by language generation module 112 or by a human operator and can be stored in association with the pre-generated prompts. As discussed further herein, natural-language responses generated by a human operator or language model can be stored in cache database 120 with an assigned response ID. The response ID is also saved as metadata in vector database 160 in association with the corresponding database vector.

Vector database 160 can also store indicators representing the relevance of an associated natural-language response to the user-generated prompt, as discussed further herein. Relevance indicators are user-provided in response to a server-provided response to the user-generated prompt and can generally indicate approval or disapproval of the server-provided response. User-provided relevance indicators are received as relevance data by server 100 and stored in vector database 160 in association with the response ID. Because retrieved responses can be used for multiple user queries, each response ID can be associated with multiple relevance indicators. Relevance indicators generally do not affect the initial querying of vector database 160 for responding to a user-generated prompt. However, relevance indicators can be used to refine the selection of results of the vector database query or provide alternative responses should an initial response to a user-generated prompt be disapproved by the user. Response IDs having more disapproval indicators than approval indicators may be purged, via server 100, from vector database 160 along with their associated database vectors stored in vector database 160. Natural-language responses corresponding to the purged response ID can similarly be purged from cache database 120.

Vector database 160 can also store vector embeddings of pre-generated text usable to provide context to the language model(s) of language generation module 112. For example, vector database 160 can store vector embeddings representative of entity-specific information, including text documents (e.g., company human resource policies, technical support, etc.) useable for generating responses to user queries. Text documents can be separated into smaller text segments (e.g., paragraphs) according to size and/or content. The natural-language text and representative vector embeddings can be stored in association in vector database 160 for retrieval in generating responses, via language generation module 112, to user queries. Vector embeddings representative of natural-language text used to inform response generation are referred to herein as “context vectors.” Vector database 160 can be queried to identify context vectors and associated natural-language text relevant to a user-generated natural-language prompt. The associated natural-language text can be retrieved by server 100 and used by language generation module 112 for generating a response to the user-generated natural-language prompt.

FIG. 1 depicts a single vector database 160 in system 10 for illustrative purposes and explanatory clarity. In some examples, server 100 can include multiple vector databases to store and organize vectors representative of different types of data, such that each vector database stores and organizes a single type of data, such as database vectors (representative of natural-language prompts) and context vectors (representative of natural-language text used to inform language model response generation).

In some examples, vector database 160 can be partitioned such that different partitions of vector database 160 store vector embeddings of, for example, natural-language prompts and vector embeddings of natural-language text used to inform language model response generation. Server 100 can select one or more relevant partitions of vector database 160 and query those partitions with a vector embedding representative of the user-generated natural-language prompt.

The vector embeddings of vector database 160 can represent any suitable length of text, including phrases, sentences, paragraphs, etc. The vector embeddings can capture semantic information and contextual information of the prompts.

Server 100 can separate complex user-generated prompts into simplified prompts (e.g., in examples where a single prompt includes more than one question or request for information and/or separable questions or requests for information), and store vector embeddings of the simplified natural-language prompts in vector database 160. Server 100 can separate user-generated prompts into simplified prompts based on content of the question or request of the user-generated prompt. For example, user-generated prompts requesting information that necessitates multiple answers or responses pertaining to different information (e.g., information pertaining to sick-leave policy and vacation policy) can be separated into multiple prompts (e.g., one requesting information relating to the sick-leave policy and the other requesting information relating to the vacation policy).

Server 100 can use a natural-language processing algorithm or another suitable algorithm or machine learning model to separate complex user-generated prompts into simpler, logical natural-language prompts. In some examples, server 100 can be configured to identify complex user-generated prompts, for example, by use of multiple question marks, use of multiple question identifiers (i.e., when, where, why, who, what, how), use of conjunctions “and,” or “or,” etc. In some examples, the user-generated prompt can be submitted first to a small or large language model of language generation module 112 to separate complex user-generated prompts into two or more logical natural-language prompts for further processing.

Separating complex or multi-part prompts according to content can increase the likelihood of identifying similar vector embeddings stored in vector database 160. As discussed further herein, vector embeddings of user-generated prompts, for which user-approved responses are provided, are stored as database vectors in vector database 160 and can be queried in response to new user-generated prompts. Querying database vectors representative of simplified user-generated prompts can increase the likelihood of identifying a vector embedding similar to a vector embedding of new user-generated prompts and can increase the relevancy of retrieved responses provided to new user-generated prompts.

To query vector database 160, server 100 and/or vector database 160 can generate a vector embedding of query text (i.e., user-generated natural-language prompt) and compare that vector embedding to the database vectors stored in vector database 160. The vector embedding of the query text is referred to herein as a “query vector.” The query vector can be generated using the same embedding algorithm and/or have the same number of dimensions as the database vectors (i.e., the vector embeddings of vector database 160 representative of natural-language prompts). Each database vector can have a unique identification label or vector ID stored as metadata in association with the database vector in vector database 160. Database vectors having a similarity score above a particular threshold and/or having the highest overall similarity to the query vector can be returned in response to the query. Vector similarity can be assessed by cosine similarity, cartesian similarity, and/or any other suitable test for assessing vector similarity. Each database vector is associated with a response ID. The vector ID or associated natural-language prompt and the response ID associated with the returned database vector can be retrieved and provided to server 100.

Server 100 generates or retrieves natural-language text responses based on the user-generated natural-language prompts. Server 100 first queries vector database 160 to identify a database vector having the highest overall similarity to the query vector and meeting a predetermined similarity threshold. If a database vector is identified, the associated response ID is provided to server 100 for retrieval of the corresponding natural-language response from cache database 120, discussed further herein. The natural-language response from cache database 120 is transmitted to server 100 for transmittal to user device 140. If a database vector is not identified in the querying of vector database 160, server 100 can submit the user-generated natural-language prompt to language generation module 112 to provide a language-model generated response, which can be transmitted to user device 140.

Cache database 120 provides in-memory data storage of natural-language responses and response IDs. The response IDs link natural-language responses to their associated natural-language prompts or database vectors in vector database 160. Data stored in cache database 120 is retrievable by server 100. Use of cache database 120 can accelerate data access, significantly reducing response latency. Cache database 120 can be remotely connected to server 100 as illustrated in FIG. 1 or locally connected to server 100. As described further herein, the number of response IDs and associated natural-language responses can increase with use of system 10.

WAN 170 is a wide-area network suitable for connecting servers (e.g., server 100) and other computing devices that are separated by greater geographic distances than the devices of a local network, such as a local network connecting server 100 to user device 140 and/or databases 150A-N. WAN 170 includes network infrastructure for connecting devices separated by larger geographic distances. In at least some examples, WAN 170 is the Internet. Server 100 can communicate with remote database 180, cache database 120, and user device 140 via WAN 170.

Remote database 180 is a remotely-located database accessible by server 100 via WAN 170. Remote database 180 is directly accessible (e.g., queryable) by server 100. Server 100 can access data of remote database 180 by, for example, sending queries to remote database 180. Server 100 can access data of cache database 120 by sending API commands to API 130. API 130 can then query remote cache database 120 in response to API commands issued by server 100 and can provide data retrieved by cache database 120 in response to queries to server 100. API 130 can also perform additional database operations (i.e., operations other than retrieval) on the data of remote database 180). While system 10 is shown as including one remote database 180 and one cache database 120, system 10 can include any suitable number of remote, WAN-accessible databases.

In some examples, databases 150A-N can be partitions of a single database and, in yet further examples, system 10 can include only one database 150A-N. In yet further examples, remote database 180 can be a structured or semi-structured database performing the same functions as a database 150A-N, and system 10 can lack or omit databases 150A-N. Further, in some examples, remote database 180 can at least partly operate as a vector database performing the same functions as vector database 160 and system 10 can lack a locally-hosted vector database 160. Additionally, and/or alternatively to any of the foregoing examples, system 10 can lack or omit remote database 180.

Chat module 110 is a software element of server 100 and includes one or more programs for operating a chat application in conjunction with chat client 148. The program(s) of chat module 110 receive user-generated natural-language prompts from chat clients 148 and provide those user-generated prompts to vector database 160 and/or language generation module 112. Chat module 110 is also able to provide responses generated by language generation module 112 to chat client 148. Chat client 148 is an instance of a chat application instantiated on user device 140. In some examples, additional instances of the chat application can be instantiated on additional user devices connected to server 100 via WAN 170. Chat module 110 can be configured to receive and/or request user credentials from chat client 148 and to limit access to the functionality of server 100 to users having valid user credentials. The user credentials can be one or more of a username, a password, or any other identifier suitable for identifying a particular user of the chat functionality of server 100.

Chat client 148 is a software application that can provide user prompts to server 100 and to receive responses from server 100. Chat client 148 can be, in some examples, a web browser for accessing a web application hosted by server 100 that uses the functionality of chat module 110. In other examples, chat client 148 can be a specialized software application for interacting with chat module 110 of server 100. A user-generated prompt submitted to server 100 through a chat client 148 is a natural-language text string including one or more user queries. In some examples, chat client 148 can include some or all of the functionality of chat module 110 and server 100 can lack chat module 110, such that user device 140 is able to perform the functions of chat module 110. A user can provide user-generated prompts by, for example, typing a natural-language phrase or sentence using a keyboard or a similar input device.

In some examples, chat client 148 can include a graphical user interface (e.g., operable via user interface 146) including one or more selectable graphical elements, such as one or more clickable elements and/or graphical buttons, representative of a natural-language text phrases or indicating selection of a natural-language text option from a list of options. For example, graphical elements indicating approval (e.g., thumbs up) and disapproval (e.g., thumbs down) can be provided with each response returned by server 100 to the user. A user can provide feedback to chat client 148 indicating that the response is approved or that the response is not approved, which can signal server 100 to take further action as discussed further herein. In some examples, a user can select from a list of pre-generated prompts the user wants to use as an input to or prompt for a new response. Chat client 148 can transmit the user-selected information to server 100 for subsequent action.

In some examples, chat client 148 can include a graphical user interface that displays a chat history between the user and server 100, such that a user can view previous user-submitted prompts and replies provided by server 100. Chat client 148 can display prior text replies as, for example, a conversation history or in any other suitable format. In some examples, chat client 148 can also display only the most-recent language generated by server 100.

The disclosed caching system advantageously reduces or eliminates the involvement of a language model in generating content for responses to user-generated prompts that have previously been provided or generated for the same or similar prompts. The disclosed caching system can significantly reduce the latency for response generation and can reduce or eliminate the cost associated with using the language model for prompts that are the same as or similar to prompts the language model has previously processed and responded to. User-provided relevance indicators associated with server-provided responses can help maintain the integrity of the caching system by identifying responses that do not provide relevant or helpful information and should be purged from system 10. Relevance indicators can also help identify preferred responses when querying vector database 160 identifies multiple database vectors similar to the user query and associated with different responses.

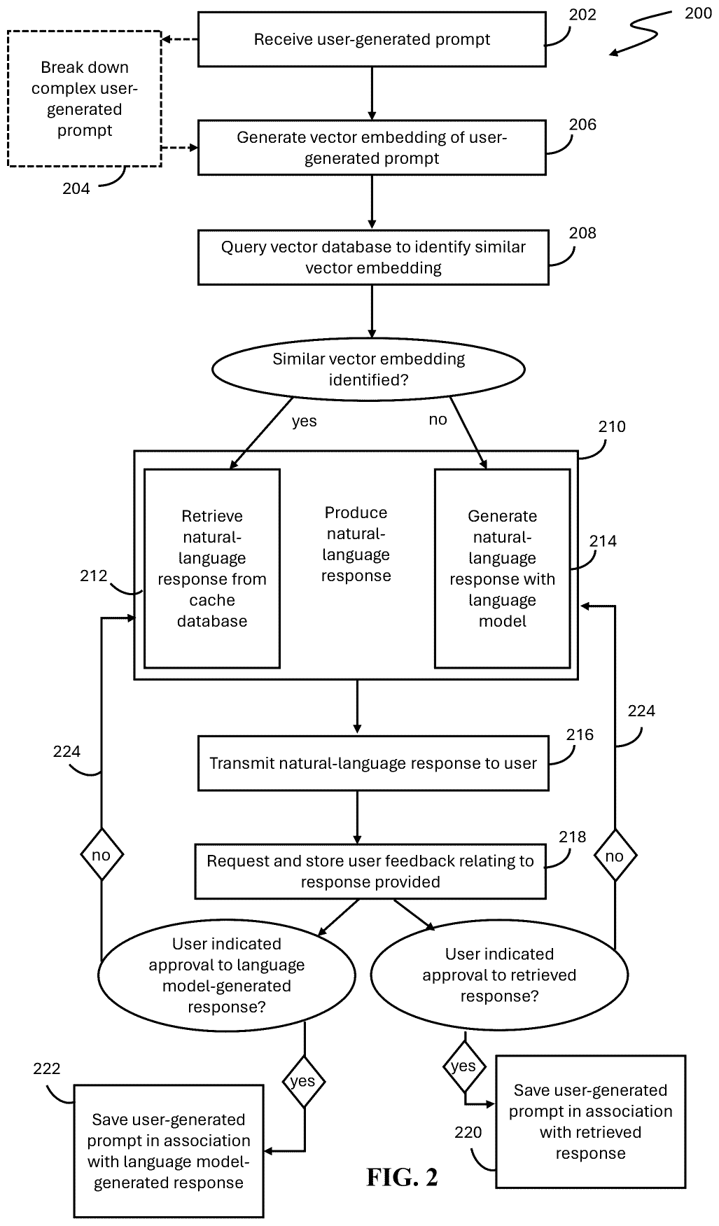

FIG. 2 is a flow diagram of method 200, which is a method of providing responses to a user-generated prompt. Method 200 is performable by system 10 (FIG. 1) or variations thereof as previously disclosed. Method 200 includes the steps of receiving a user-generated prompt (step 202), optionally separating complex user-generated prompts into simpler prompts (step 204), generating a vector embedding of the user-generated prompt (step 206), querying a vector database to identify a vector embedding representative of a natural-language prompt that is the same as or substantially similar to the user-generated prompt (step 208), producing a natural-language response to the user-generated prompt (step 210), which can include retrieving the natural-language response to the identified same or similar natural-language prompt identified in querying the vector database (step 212) or generating a natural-language response via a language model if querying the vector database does not identify a same or similar natural-language prompt (step 214), and transmitting the natural-language response to a user device (step 216). Method 200 can include the additional steps of requesting and storing user feedback relating to the natural-language responses produced (step 218), saving user-generated prompt in association with retrieved responses (step 220), saving language model-generated responses to user-generated prompts (step 222), and producing additional and alternative natural-language responses in response to user-provided feedback (step 224). Method 200 can improve user experience by reducing response latency and can reduce or eliminate redundant costs associated with language model usage by retrieving stored natural-language responses to prompts that are the same as or substantially similar to user-generated prompts, thereby avoiding usage of the language model for generating redundant responses.

In step 202, server 100 receives a user-generated prompt. A user can enter a prompt into a chat service application via user interface 148. While there are no limitations on the content of the prompt, system 10 can be uniquely configured to be responsive to common questions or requests for information specific to the entity operating or providing the chat service to users. For example, system 10 can be uniquely configured to provide information to employees of the entity providing the chat service relating to the nature of work, employment agreements, company policies, etc., and/or to customers of the entity relating, for example, to technical support or product information.

The user-generated prompt is entered by the user and received by server 100 as natural-language text, which can include one or more user queries (i.e., natural-language representations of questions or requests for information). The user-generated prompt can generally be provided in one or more sentences. Generally, restrictions need not be placed on the structure or format of the user-generated prompt. In examples where the inputs to the language model are token-limited, the user-generated prompt input text may be limited to a particular size. In some examples, the chat application may be configured to guide or provide examples or instructions for prompt generation to improve response latency and relevance. For example, the user may be encouraged to divide multi-part or multi-question prompts into multiple sentences, particularly, if the questions or requests for information are generally unrelated or would require retrieving information from different sources. Breaking up complex requests for information or questions into simpler parts can help ensure that query vectors (vector embeddings of the user-generated prompt) more closely match database vectors (vector embeddings of previously stored natural-language prompts) such that responses retrieved based on vector similarity are relevant and complete.

Absent user-generated delineation, server 100 can use a natural-language processing algorithm or another suitable algorithm (e.g., algorithm used in orchestration tools commonly used for prompt decomposition) or machine learning model to separate complex user-generated prompts into simpler, logical natural-language prompts (step 204). In some examples, server 100 can be configured to identify complex user-generated prompts, for example, by use of multiple question marks, use of multiple question identifiers (i.e., when, where, why, who, what, how), use of conjunctions “and,” or “or,” etc.

In some examples, the user-generated prompt can be submitted first to language generation module 112 to separate complex user-generated prompts into two or more logical natural-language prompts for further processing. Use of language generation module 112 can be limited at this time in the process to breaking down complex prompts. In some examples, a small language model can be used to break down complex user-generated prompts and a large language model can be used for generating responses to user-generated prompts.

In step 206, a query vector is created using the user-generated prompt received in step 202. The query vector is a vector embedding of the user-generated prompt, which can be created by server 100 (FIG. 1). As previously described, server 100 can use a natural-language processing algorithm or another suitable algorithm or machine learning model to extract the user's question or request for information from the user-generated prompt, removing one or more filler words and extraneous text segments, etc. from the user-generated prompt. Multiple query vectors may be created for a single user-generated prompt, for example, where a complex user-generated prompt has been separated into two or more natural-language prompts (e.g., two or more separable questions or requests for different information), as previously described.

In step 208, server 100 can query vector database 160 to identify one or more database vectors having a sufficient similarity to the query vector. As previously described, the database vector is a vector embedding representative of a natural-language prompt. Database vectors can include a combination of query vectors that were previously saved in vector database 160 and vector embeddings generated from natural-language prompts provided to pre-populate or prime vector database 160 prior to use. Vector database 160 can store the database vectors in association with the natural-language text represented by the database vectors. Each database vector can have a unique corresponding vector identifier (also referred to herein as “vector ID”). Each database vector is associated with a corresponding natural-language response stored external to vector database 160 and a corresponding response identifier (also referred to herein as “response ID”) stored as metadata in association with the database vector in vector database 160. Vector database 160 can continue to be populated with use. For example, as discussed further herein, each query vector can be saved as a database vector in association with the user-generated natural language prompt (or simplification thereof generated in step 204) and a corresponding response ID. Vector database 160 can additionally store indicators representing the relevance of an associated natural-language response to the user-generated prompt (or simplification thereof), as discussed further herein. Relevance indicators can be stored as relevance data in association with the response ID.

Vector database 160 can use any suitable similarity test and any suitable similarity threshold for identifying similar vectors. The similarity test can be, for example, a cosine similarity test, a cartesian similarity test, etc. The similarity threshold can be predefined. Querying vector database 160 can retrieve the non-vectorized (e.g., natural language) text corresponding to database vectors satisfying vector similarity criteria with query vectors. Both the natural-language text represented by the identified database vector and the associated response ID can be provided to server 100 for further use with method 200.

In step 210, server 100 produces a natural-language response to the user-generated prompt (or server-simplified prompts where a complex user-generated prompt is separated into multiple natural-language prompts). Server 100 retrieves from a cache database (step 212) and/or generates, via a language model (step 214), a natural-language response to the user-generated prompt. As described further herein, the action taken by server 100 in step 210 depends on the results of querying vector database 160. If querying vector database 160 identifies one or more database vectors having a sufficient similarity to the query vector (i.e., meeting a predefined similarly threshold), server 100 proceeds to step 212. If querying vector database 160 fails to identify one or more database vectors having a sufficient similarity to the query vector, server 100 proceeds to step 214. In examples in which a complex user-generated prompt has been broken into multiple prompts, each having a representative vector embedding (query vector), server 100 may retrieve a natural-language response relevant to one or more parts of the complex user-generated prompt and generate a response relevant to another one or more parts of the complex user-generated prompt.

In step 212, server 100 can retrieve the natural-language response associated with a database vector meeting the predefined similarity threshold and having the closest similarity to the query vector (i.e., highest probable relevancy). The natural-language response associated with the database vector can be retrieved from cache database 120 based on the associated response ID. As previously discussed, cache database 120 can store all natural-language responses with a unique corresponding response ID. The response ID is also stored in vector database 160 in association with a corresponding database vector. Each natural-language response or response ID can be associated with more than one database vector. For example, each natural-language response can be associated with the database vector and the related query vector, which is subsequently stored as a database vector in vector database 160. Server 100 avoids involvement of a language model by retrieving the natural-language response from cache database 120. The retrieval of the natural-language response from cache database 120 can significantly reduce response latency as compared to generating content of a response via a language model. Additionally, response retrieval avoids redundant use of a language model to respond to similar inquiries and thereby avoids redundant costs for businesses charged for language model use on a per-use basis.

In step 214, server 100 generates a natural-language response to the user-generated natural-language prompt using a trained, computer-implemented machine-learning model (also referred to herein as “language model”). In some examples, the language model can be a large language model and/or a transformer model. The language model is configured to generate a natural-language text response based on a natural-language text prompt. The natural-language text generated in step 214 is responsive to the to the user's question(s) or request for information provided in the user-generated prompt. The natural-language response can be based on the user-generated natural-language prompt or one or more simplified natural-language prompts generated from a complex user-generated natural-language prompt in step 204. As previously discussed, in some examples, a complex user-generated prompt can be broken down into multiple logical prompts (e.g., a multi-part question can be broken down into multiple questions or a request for multiple types of information can be separated into multiple requests according to the type of information requested). Before submitting any of the natural-language prompts to the language model for response generation, server 100 first attempts to retrieve responses from cache database 120 based on vector similarity as described in step 212. Only natural-language prompts, for which querying vector database 160 fails to identify a database vector sufficiently similar to the query vector representative of the natural-language prompt, are sent to the language model for response generation.

The language model can generate a response using retrieval augmented generation (RAG) based on natural language retrieved from vector database 160. Vector database 160 can be populated with natural language text and corresponding vector embeddings (context vectors) of relevant entity-provided information, such as human resource policy documents, frequently asked questions documents, and the like, to ensure that language model-generated responses contain accurate information relevant to user-generated prompts and to reduce AI hallucinations.

Server 100 can query vector database 160 to identify context vectors relevant to the query vector and can retrieve the corresponding natural-language text for use by the language model in generating a response. Server 100 can provide the user-generated natural-language prompt (or one or more simplified prompts if broken down from a complex prompt) in addition to contextual information retrieved from vector database 160 to language generation module 112. The computer-implemented machine-learning model(s) of language generation module 112 generates a natural-language response to the user-generated natural-language prompt using the user-generated prompt (or simplified prompt) and the information retrieved from vector database 160 provided to language generation module 112. The natural language generated by language generation module 112 is responsive to the user's query (e.g., question or request for information). The use of the retrieved information from vector database 160 provides additional context to the trained, computer-implemented machine-learning model and improves the accuracy of the natural-language response generated thereby, reducing the occurrence of AI hallucinations or fabrications that can occur during natural-language text generation and, further, increasing the likelihood that language generated by language generation module 112 relates to the user's query.

In step 216, server 100 transmits the natural-language response to a user device (e.g., user device 140). For complex user-generated prompts that have been separated into multiple prompts, server 100 can transmit the associated natural-language responses as they are available, or in an order corresponding to an order of queries in the original prompt. Generally, it will take less time for server 100 to retrieve the associated natural-language responses from cache 120 than it will take to generate natural-language responses using the language model. As such, retrieved responses can be transmitted to the user device prior to the language model-generated responses.

In some examples, system 10 can incorporate user feedback regarding the relevancy of the natural-language responses to the user-generated prompt. In step 218, server 100 can request and store user feedback relating to the natural-language responses produced. In addition to transmitting the natural-language response(s) to the user device, server 100, via the chat application, can request that the user indicate whether the response provided was helpful or addressed their question or request for information. This may be achieved by providing, for example, icons such as a thumbs up and thumbs down or “yes” and “no” boxes, for the user to select indicating approval or disapproval of the provided response. Such feedback can be requested for each response provided including those in response to simplified prompts that have been broken down from complex user-generated prompts.

In step 220, if the user upvotes or approves of a retrieved response, the query vector can be saved in vector database 160 as a database vector in association with the response ID corresponding to the approved natura-language response. The relevance indicator representing approval can be stored as metadata in vector database 160 in association with the response ID. As such, the response ID can be associated with multiple database vectors, including the retrieved database vector and the query vector, now saved as a database vector. Additionally, each relevance indicator associated with a response ID can be associated with multiple database vectors.

In step 222, if the user upvotes or approves of a language model-generated response, the language model-generated natural-language response can be stored in cache database 120 and the query vector can be saved in vector database 160 as a database vector. The language model-generated response is stored in cache database 120 with a unique response ID, which is also stored as metadata in association with the query vector, now saved as a database vector, in vector database 160. All approved and stored language model-generated responses become retrievable responses, which can be retrieved and provided in response to subsequently submitted user-generated prompts.

If the user downvotes or disapproves of a retrieved response, a relevance indicator representing disapproval can be saved in vector database 160 as metadata in association with the response ID and all corresponding database vectors, including the query vector now saved as a database vector in vector database 160. If the user downvotes or disapproves of a language model-generated response, the language model-generated response can be discarded (i.e., not saved in cache database 160 or in association with the query vector).

Each time a user upvotes or downvotes a server-provided response, the relevance indicator can be stored in vector database 160 in association with the response ID. The relevance indicators can be amassed such that the number of relevance indicators grows each time a user provides feedback relating to the retrieved response. As such, each response ID may be associated with multiple relevance indicators, which can be used to refine the selection of results of a vector database query or provide alternative responses as discussed further herein.

The presence of relevance indicators generally will not affect the initial identification of a database vector substantially similar to the query vector in step 210. The initial identification of a similar database vector can be based solely on vector similarity, recognizing that user-provided feedback may not always be an accurate measure of relevance. In some examples, response IDs associated with more disapproval indicators than approval indicators may be removed from vector database 160 along with their associated database vectors stored in vector database 160. Server 100 can be configured to purge vector database 160 and cache database 120 of response IDs and all associated data (e.g., database vector, natural-language prompt, and natural-language response) when disapproval indicators outnumber approval indicators for the response ID.

In step 224, server 100 can produce additional and/or alternative natural-language responses in response to user-provided feedback, indicating dissatisfaction or disapproval of the response. In response to a downvoted or disapproved retrieved response from cache database 120, server 100 can identify the database vector that is next closest in similarity to the query vector and associated with a different response ID. Server 100 can retrieve and transmit the natural-language response corresponding to the new response ID to the user device. Server 100 can retrieve the associated natural-language response from cache database 120 based on response ID as provided in step 212. The user can again have an opportunity to approve or disapprove of the response by selecting a relevance indicator. Relevance indicators can be stored as metadata with the associated response ID as previously described.

Alternatively, or subsequently, server 100 can compile a list of natural-language prompts that are similar to the user-generated prompt based on database vectors identified as having the next closest similarity to the query vector and within the predefined similarity threshold but associated with different response IDs. The list of similar natural-language prompts can be transmitted to the user device in a format that allows the user to select the natural-language prompt they deem most relevant. For example, the user may be provided the list of natural-language prompts with the explanation that the questions or requests for information provided in the list may be similar to what they are asking or requesting and ask if the user would like to view the responses to any of the questions or requests for information provided in the list. Consistent with step 212, server 100 can retrieve the natural-language response associated with the user-selected natural-language prompt based on response ID and transmit the natural-language response to the user device. The user can again have an opportunity to approve or disapprove of the natural-language response by selecting a relevance indicator. The user may also choose to select a different natural-language prompt from the list provided, for which the associated response can be retrieved and transmitted. Relevance indicators can be stored as metadata with the associated response ID as previously described.

In some examples, vector database 160 may not contain additional database vectors that meet the criteria of having sufficient similarity to the query vector representative of the user-generated prompt and being associated with a different response ID than the original query vector identified. In such scenario, server 100 can generate a natural-language response to the user-generated natural-language prompt using the language model as described in step 214. Again, the user can have an opportunity to approve or disapprove of the newly provided natural-language response by selecting a relevance indicator. Approved natural-language responses can be saved in association with the user-generated prompt, related by response ID. The query vector representative of the user-generated prompt can be saved in vector database 160 as a database vector, which can be queried in response to subsequent user-generated prompts. The approved natural-language response can be saved in cache database 120 for retrieval by corresponding response ID. Relevance indicators can be stored as metadata with the associated response ID in vector database 160 as previously described.

In response to a downvoted or disapproved language model-generated response, server 100 can generate a new natural-language response to the original or a modified user-generated natural-language prompt using the language model as described in the preceding paragraph and in step 214. Server 100 may prompt the user to clarify or rephrase their question or request for information in effort to generate a more relevant response. Multiple iterations of prompt modification and response generation may be made to provide a response that the user approves. As previously discussed, language model-generated responses that are not approved are not saved in association with their respective user-generated prompt. These responses can be discarded as they have not been identified as approved for any user-generated natural-language prompt or pre-populated prompt in vector database 160. Any language model-generated responses that are tagged as being user-approved can be saved in association with the corresponding user-generated prompt and representative query vector as previously described. Language model-generated responses saved in cache database 120 become retrieval responses in subsequent uses of the chat service application.

Vector database 160 and cache database 120 can be developed or populated through use, as described above, with many of the first responses provided to a user-generated natural-language prompts being generated by a language model and saved to cache database 120. In some examples, vector database 160 and cache database 120 can be pre-populated with natural-language prompts and vector embeddings (stored in vector database 160) and corresponding natural-language responses (stored in cache database 120), such that the chat service application is primed and ready for retrieving responses from cache database 120 upon initial use of the chat service application.

As previously discussed, vector database 160 can be manually populated, for example, by inputting frequently asked questions and responses, or can be populated using a language model to generate questions and responses based on content provided to the language model. Questions can be stored in vector database 160 as natural-language prompts and corresponding vector embeddings and with the associated response IDs stored as metadata. Natural-language responses can be stored in cache database 120 with the associated response ID.

Method 200 can improve user experience by reducing response latency and can reduce or eliminate redundant costs of language model usage by retrieving stored natural-language responses to prompts that are the same as or substantially similar to user-generated prompts, thereby avoiding usage of the language model for generating responses.

### Discussion of Possible Embodiments

The following are non-exclusive descriptions of possible embodiments of the present invention.

A method of generating an automated response to a user prompt includes receiving, by a processor of a network-connected device, a first natural-language prompt from a user; generating, by the processor, a first vector embedding representative of the first natural-language prompt; querying, by the processor, a vector database using the first vector embedding to identify a second vector embedding representative of a second natural-language prompt and having a similarity score with the first vector embedding above a defined threshold, wherein the vector database comprises a plurality of vector embeddings stored in association with a response identifier, each vector embedding representative of a natural language prompt; and producing a first natural-language response to the first natural-language prompt, wherein producing the first natural-language response comprises retrieving, by the processor, the first natural-language response to the second natural language prompt from a cache database when the second vector embedding is identified in querying the vector database.

The method of the preceding paragraph can optionally include, additionally and/or alternatively, any one or more of the following features, configurations, additional components, and/or steps disclosed herein:

In an embodiment of the preceding method, producing the first natural-language response can include generating, by a language model executed by the processor, the first natural-language response to the first natural-language prompt when querying the vector database fails to identify the second vector embedding.

In an embodiment of any of the preceding methods, the first natural-language response retrieved from the cache database can be a response previously generated by the language model and stored in the cache database.

An embodiment of any of the preceding methods can further include requesting, by the processor, the user to approve of or disapprove of the first natural-language response, based on content of the first natural-language response and relevance to the first natural-language prompt, by selecting a relevance indicator on a user device, the relevance indicator representing approval or disapproval.

An embodiment of any of the preceding methods can further include receiving, by the processor, a relevance datum representative of the relevance indicator; and storing, by the processor, the relevance datum in association with the response identifier of the first natural-language response in the vector database.

An embodiment of any of the preceding methods can further include storing, by the processor, the first vector embedding in association with the response identifier of the first natural-language response in the vector database.

An embodiment of any of the preceding methods can further include storing, by the processor in response to receiving a relevance datum representing approval of the first natural-language response, the first natural-language response and corresponding response identifier of the first natural-language response in the cache database; and storing, by the processor, the first vector embedding and associated response identifier of the first natural-language response in the vector database.

An embodiment of any of the preceding methods can further include repeating the step of retrieving, by the processor, the first natural-language response to the second natural language prompt from the cache database for a plurality of natural-language prompts received from a plurality of users.

An embodiment of any of the preceding methods can further include storing, by the processor, a plurality of relevance indicators in association with the response identifier for the first natural-language response in the vector database.

An embodiment of any of the preceding methods can further include producing, by the processor, an alternative natural language response to the first natural language prompt when the user has selected the relevance indicator representing disapproval of the first natural-language response.

In an embodiment of any of the preceding methods producing the alternative natural-language response can include identifying a third vector embedding representative of a third natural-language prompt and having a similarity score with the first vector embedding above the defined threshold and closest to the second vector embedding similarity score; and retrieving, by the processor, the alternative natural-language response to the third natural-language prompt from the cache database, wherein the alternative natural-language response differs from the first natural-language response.

An embodiment of any of the preceding methods can further include requesting, by the processor, the user to approve of or disapprove of the alternative natural-language response, based on content of the alternative natural-language response and relevance to the alternative natural-language prompt, by selecting the relevance indicator on the user device representing approval or disapproval; receiving, by the processor, the relevance indicator; and storing, by the processor in response to receiving a relevance datum representing approval of the alternative natural-language response, the first vector embedding and associated response identifier of the alternative natural-language response in the vector database.

An embodiment of any of the preceding methods can further include, in response to the user selecting the relevance indicator representing disapproval of the first natural-language response, generating, by a language model executed by the processor, an alternative natural-language response to the first natural-language prompt.

An embodiment of any of the preceding methods can further include requesting, by the processor, the user to approve of or disapprove of the alternative natural-language response, based on content of the alternative natural-language response and relevance to the alternative natural-language prompt, by selecting the relevance indicator on the user device representing approval or disapproval; receiving, by the processor, a relevance datum representative of the relevance indicator; storing, by the processor in response to receiving a relevance datum representing approval of the alternative natural-language response, the alternative natural-language response and corresponding response identifier in a cache database; and storing, by the processor, the first vector embedding and associated response identifier of the alternative natural-language response in the vector database.

An embodiment of any of the preceding methods can further include, in response to the user selecting the relevance indicator representing disapproval of the first natural-language response, producing, by the processor, a list of suggested natural language prompts, each suggested natural language prompt having a vector embedding representative of the suggested natural-language prompt and having a similarity score with the first vector embedding above the defined threshold; and a request for the user to select a suggested natural-language prompt from the list of suggested natural-language prompts; and can further include retrieving, by the processor, an alternative natural-language response associated with the selected suggested natural-language prompt from the cache database. The first natural-language response is a response retrieved from the cache database.

In an embodiment of any of the preceding methods, each vector embedding of the plurality of vector embeddings can have an associated natural-language response generated by the language model and, wherein the associated natural-language responses are stored in the cache database with a unique corresponding response identifier and wherein the unique response identifier is stored in the vector database in association with the associated vector embedding.

In an embodiment of any of the preceding methods, retrieving, by the processor, the first natural-language response to the second natural language prompt from the cache database can include retrieving the first natural-language response by the associated response identifier in the cache database, the associated response identifier stored in association with the second vector embedding in the vector database.

A system includes a vector database configured to store vector embeddings representative of natural-language prompts and associated response identifiers; a cache database configured to store the associated response identifiers and corresponding natural-language responses to the natural-language prompts, each response identifier associated with a vector embedding of the vector database and a natural-language response of the cache database; and a network-connected device in electronic communication with the vector database and the cache database. The network-connected device includes a processor configured to receive a first natural-language prompt from a user, generate a query vector representative of the first natural-language prompt, query the vector database using query vector to identify a database vector having a similarity score with the query vector above a defined threshold, the database vector associated with a response identifier, and produce a first natural-language response to the first natural-language prompt by retrieving, from the cache database, a first natural-language response associated with the response identifier of the database vector when the database vector is identified; and submitting the first natural language prompt to a language model, executed by the processor, to generate a first natural-language response when the database vector is not identified.

The system of the preceding paragraph can optionally include, additionally and/or alternatively, any one or more of the following features, configurations, and/or additional components disclosed herein:

In an embodiment of the preceding system, each response identifier can be associated with one or more database vectors stored in the vector database and a single natural-language response stored in the cache database.

In an embodiment of any of the preceding systems, the processor can be further configured to receive, from the user, a relevance datum representing approval or disapproval of the first natural-language response.

In an embodiment of any of the preceding systems, the processor can be further configured to store the relevance datum in association with the response identifier in the vector database.

In an embodiment of any of the preceding systems, the processor can be further configured to store the query vector as a database vector in the vector database in association with a retrieved first natural-language response.

In an embodiment of any of the preceding systems, the processor can be further configured to store the query vector as a database vector in the vector database and store the first-natural language response in the cache database when the first natural-language response is generated by the language model and when the relevance datum received represents approval of the first-natural language response.

In an embodiment of any of the preceding systems, the processor can be further configured to separate the first natural-language prompt into a plurality of vector embeddings when the first natural-language prompt includes multiple parts for which natural-language responses will differ in content.

In an embodiment of any of the preceding systems, the processor can be further configured to query the vector database using the query vector to identify a plurality of database vectors having a similarity score with the query vector above a defined threshold, wherein database vectors of the plurality of database vectors have different associated response identifiers; retrieve, from the vector database, a plurality of natural-language prompts represented by the plurality of query vectors; provide, by the processor, a list of the plurality of natural-language prompts to a user device; and retrieve, from the cache database, a natural-language response associated with a natural-language prompt selected by a user from the list of the plurality of natural-language prompts.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of generating an automated response to a user prompt, the method comprising:
receiving, by a processor of a network-connected device, a first natural-language prompt from a user;
generating, by the processor, a first vector embedding representative of the first natural-language prompt;
querying, by the processor, a vector database using the first vector embedding to identify a second vector embedding representative of a second natural-language prompt and having a similarity score with the first vector embedding above a defined threshold, wherein the vector database comprises a plurality of vector embeddings stored in association with a response identifier, each vector embedding representative of a natural language prompt; and
producing a first natural-language response to the first natural-language prompt, wherein producing the first natural-language response comprises retrieving, by the processor, the first natural-language response to the second natural language prompt from a cache database when the second vector embedding is identified in querying the vector database.

2. The method of claim 1, wherein producing the first natural-language response comprises generating, by a language model executed by the processor, the first natural-language response to the first natural-language prompt when querying the vector database fails to identify the second vector embedding.

3. The method of claim 2, wherein the first natural-language response retrieved from the cache database is a response previously generated by the language model and stored in the cache database.

4. The method of claim 2 and further comprising requesting, by the processor, the user to approve of or disapprove of the first natural-language response, based on content of the first natural-language response and relevance to the first natural-language prompt, by selecting a relevance indicator on a user device, the relevance indicator representing approval or disapproval.

5. The method of claim 4 and further comprising:
receiving, by the processor, a relevance datum representative of the relevance indicator; and
storing, by the processor, the relevance datum in association with the response identifier of the first natural-language response in the vector database.

6. The method of claim 5 and further comprising:
storing, by the processor, the first vector embedding in association with the response identifier of the first natural-language response in the vector database.

7. The method of claim 5 and further comprising:
storing, by the processor in response to receiving a relevance datum representing approval of the first natural-language response, the first natural-language response and corresponding response identifier of the first natural-language response in the cache database; and
storing, by the processor, the first vector embedding and associated response identifier of the first natural-language response in the vector database.

8. The method of claim 5 and further comprising repeating the step of retrieving, by the processor, the first natural-language response to the second natural language prompt from the cache database for a plurality of natural-language prompts received from a plurality of users.

9. The method of claim 8 and further comprising storing, by the processor, a plurality of relevance indicators in association with the response identifier for the first natural-language response in the vector database.

10. The method of claim 4 and further comprising producing, by the processor, an alternative natural language response to the first natural language prompt when the user has selected the relevance indicator representing disapproval of the first natural-language response.

11. The method of claim 10, wherein producing the alternative natural-language response comprises:
identifying a third vector embedding representative of a third natural-language prompt and having a similarity score with the first vector embedding above the defined threshold and closest to the second vector embedding similarity score; and
retrieving, by the processor, the alternative natural-language response to the third natural-language prompt from the cache database, wherein the alternative natural-language response differs from the first natural-language response.

12. The method of claim 11 and further comprising:
requesting, by the processor, the user to approve of or disapprove of the alternative natural-language response, based on content of the alternative natural-language response and relevance to the alternative natural-language prompt, by selecting the relevance indicator on the user device representing approval or disapproval;
receiving, by the processor, the relevance indicator; and
storing, by the processor in response to receiving a relevance datum representing approval of the alternative natural-language response, the first vector embedding and associated response identifier of the alternative natural-language response in the vector database.

13. The method of claim 4 and further comprising, in response to the user selecting the relevance indicator representing disapproval of the first natural-language response:
generating, by a language model executed by the processor, an alternative natural-language response to the first natural-language prompt.

14. The method of claim 13 and further comprising:
requesting, by the processor, the user to approve of or disapprove of the alternative natural-language response, based on content of the alternative natural-language response and relevance to the alternative natural-language prompt, by selecting the relevance indicator on the user device representing approval or disapproval;
receiving, by the processor, a relevance datum representative of the relevance indicator;
storing, by the processor in response to receiving a relevance datum representing approval of the alternative natural-language response, the alternative natural-language response and corresponding response identifier in a cache database; and
storing, by the processor, the first vector embedding and associated response identifier of the alternative natural-language response in the vector database.

15. The method of claim 4 and further comprising, in response to the user selecting the relevance indicator representing disapproval of the first natural-language response, wherein the first natural-language response is a response retrieved from the cache database:
producing, by the processor:
a list of suggested natural language prompts, each suggested natural language prompt having a vector embedding representative of the suggested natural-language prompt and having a similarity score with the first vector embedding above the defined threshold; and
a request for the user to select a suggested natural-language prompt from the list of suggested natural-language prompts; and
retrieving, by the processor, an alternative natural-language response associated with the selected suggested natural-language prompt from the cache database.

16. The method of claim 2, wherein each vector embedding of the plurality of vector embeddings has an associated natural-language response generated by the language model and, wherein the associated natural-language responses are stored in the cache database with a unique corresponding response identifier and wherein the unique response identifier is stored in the vector database in association with the associated vector embedding.

17. The method of claim 2, wherein retrieving, by the processor, the first natural-language response to the second natural language prompt from the cache database comprises retrieving the first natural-language response by the associated response identifier in the cache database, the associated response identifier stored in association with the second vector embedding in the vector database.

18. A system comprising:
a vector database configured to store vector embeddings representative of natural-language prompts and associated response identifiers;
a cache database configured to store the associated response identifiers and corresponding natural-language responses to the natural-language prompts, each response identifier associated with a vector embedding of the vector database and a natural-language response of the cache database; and
a network-connected device in electronic communication with the vector database and the cache database, the network-connected device comprising:
a processor configured to:
receive a first natural-language prompt from a user;
generate a query vector representative of the first natural-language prompt;
query the vector database using query vector to identify a database vector having a similarity score with the query vector above a defined threshold, the database vector associated with a response identifier; and
produce a first natural-language response to the first natural-language prompt by:
retrieving, from the cache database, a first natural-language response associated with the response identifier of the database vector when the database vector is identified; and
submitting the first natural language prompt to a language model, executed by the processor, to generate a first natural-language response when the database vector is not identified.

19. The system of claim 18, wherein each response identifier is associated with one or more database vectors stored in the vector database and a single natural-language response stored in the cache database.

20. The system of claim 18, wherein the processor is further configured to receive, from the user, a relevance datum representing approval or disapproval of the first natural-language response.

21. The system of claim 20, wherein the processor is further configured to store the relevance datum in association with the response identifier in the vector database.

22. The system of claim 21, wherein the processor is further configured to store the query vector as a database vector in the vector database in association with a retrieved first natural-language response.

23. The system of claim 20, wherein the processor is further configured to store the query vector as a database vector in the vector database and store the first-natural language response in the cache database when the first natural-language response is generated by the language model and when the relevance datum received represents approval of the first-natural language response.

24. The system of claim 18, wherein the processor is further configured to separate the first natural-language prompt into a plurality of vector embeddings when the first natural-language prompt includes multiple parts for which natural-language responses will differ in content.

25. The system of claim 18, wherein the processor is further configured to:
query the vector database using the query vector to identify a plurality of database vectors having a similarity score with the query vector above a defined threshold, wherein database vectors of the plurality of database vectors have different associated response identifiers;
retrieve, from the vector database, a plurality of natural-language prompts represented by the plurality of query vectors;
provide, by the processor, a list of the plurality of natural-language prompts to a user device; and
retrieve, from the cache database, a natural-language response associated with a natural-language prompt selected by a user from the list of the plurality of natural-language prompts.
